(19) United States
(12) Patent Application Publication
(10) Pub. No.: US 2010/0176662 A1
(43) Pub. Date: Jul. 15, 2010

(54) Power supply apparatus

(75) Inventors: Hirokazu Nakagawa, Kawasaki (JP); Naohiko Kajio, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,849

(22) Filed: Mar. 23, 2010

Related U.S. Application Data
(63) Continuation of application No. PCT/JP2007/069030, filed on Sep. 28, 2007.

(51) Int. Cl. G05F 3/06

(52) U.S. Cl. 307/151

(57) ABSTRACT

A power supply apparatus includes a power supply circuit and a module that has a replaceable or detachable structure. The power supply apparatus copes with an equipment that uses a single-phase A.C. power by connecting a single-phase power reception module to the power supply apparatus, and copes with an equipment that uses a three-phase A.C. power by connecting a three-phase power reception module to the power supply apparatus.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2007/069030 filed on Sep. 28, 2007, in the Japanese Patent Office, the disclosure of which is hereby incorporated by reference.

### FIELD

The present invention generally relates to power supply apparatuses, and more particularly to a power supply apparatus for supplying single-phase (electric) power or three-phase power.

### BACKGROUND

The power used by an equipment (or apparatus) is determined by the specifications or the set-up environment of the equipment. For example, an equipment, such as a server, may use single-phase A.C. power (hereinafter simply referred to as “single-phase power”) or three-phase A.C. power (hereinafter simply referred to as “three-phase power”) depending on the specifications of the equipment or the set-up environment of the equipment. Hence, a single-phase power supply apparatus for supplying the single-phase power or a three-phase power supply apparatus for supplying the three-phase power must be provided depending on the type of power used by the equipment. For this reason, manufacturers of the power supply apparatuses must manufacture two kinds of power supply apparatuses, namely, the single-phase power supply apparatus for supplying the single-phase power and the three-phase power supply apparatus for supplying the three-phase power.

In addition, when a user of the equipment using the single-phase power wishes to change the type of power to the three-phase power in order to cope with a change in the set-up environment of the equipment, for example, the power supply apparatus must also be changed from the single-phase power supply apparatus to the three-phase power supply apparatus. However, in the case of the equipment, such as the server, the size of the power supply apparatus is relatively large. For example, the height, the width and the depth of the power supply apparatus respectively are 180 cm, 30 cm and 100 cm, for example. Consequently, the cost associated with the changing of the power supply apparatus also becomes relatively high.

For example, a Japanese Patent No. 3289418 and a Japanese Laid-Open Patent Publication No. 5-146154 propose techniques for automatically discriminating whether the input power is the single-phase power or the three-phase power, and switching the input power so that the D.C. output becomes constant.

Conventionally, it is necessary to provide a number of kinds of power supply apparatuses corresponding to the number of type of power used by the equipments. For this reason, it is difficult for the manufacturer to improve the productivity of the power supply apparatus. In addition, when the user changes the type of power used by the equipment, the user must also change the power supply apparatus, and the utility or equipment work associated with the changing of the power supply apparatus is relatively large. As a result, the cost associated with the changing of the power supply apparatus becomes relatively high.

### SUMMARY

Accordingly, it is an object in one aspect of the invention to improve the productivity of the manufacturer of the power supply apparatus, and to simplify the utility or equipment work associated with the power supply apparatus when the user changes the type of the power supply apparatus used by the equipment.

According to one aspect of the present invention, there is provided a power supply apparatus comprising a first power supply circuit having first and second input terminals and configured to input single-phase A.C. power from the first and second input terminals; a second power supply circuit having third and fourth input terminals and configured to input the single-phase A.C. power from the third and fourth input terminals; a third power supply circuit having fifth and sixth input terminals and configured to input the single-phase A.C. power from the fifth and sixth input terminals; and a replaceable power reception module selected from a group consisting of a single-phase power reception module and a three-phase power reception module, wherein the single-phase power reception module includes a first single-phase power output terminal coupled to the first, third and fifth input terminals, and a second single-phase power output terminal coupled to the second, fourth and sixth input terminals, and outputs external single-phase A.C. power from the first and second single-phase power output terminals, and the three-phase power reception modules includes a first three-phase power output terminal coupled to the first and third input terminals, a second three-phase power output terminal coupled to the second and fifth input terminal, and a third three-phase power output terminal coupled to the fourth and sixth input terminals, and outputs external three-phase A.C. power from the first, second and third three-phase power output terminals.

According to one aspect of the present invention, there is provided a power supply apparatus comprising a power reception module comprising first through (3N−1) power supply circuits having a pair of first and second input terminals, a pair of seventh and eighth input terminals, . . . , and a pair of (6N−5)th and (6N−4)th input terminals, and inputting single-phase powers from the pair of first and second input terminals, the pair of seventh and eighth input terminals, . . . , and the pair of (6N−5)th and (6N−4)th input terminals, where N is an integer greater than or equal to 3; second through (3N−2)th power supply circuits having a pair of third and fourth input terminals, a pair of ninth and tenth input terminals, . . . , and a pair of (6N−3)th and (6N−2)th input terminals, and inputting single-phase powers from the pair of third and fourth input terminals, the pair of ninth and tenth input terminals, . . . , and the pair of (6N−3)th and (6N−2)th input terminals; and third through 3Nth power supply circuits having a pair of fifth and sixth input terminals, a pair of eleventh and twelfth input terminals, . . . , and a pair of (6N−1)th and 6Nth input terminals, and inputting single-phase powers from the pair of fifth and sixth input terminals, the pair of eleventh and twelfth input terminals, . . . , and the pair of (6N−1)th and 6Nth input terminals; and a power module mounting part configured to receive the power reception module in a detachable manner, wherein the power reception module is selected from a group consisting of a single-phase power reception module and a three-phase power reception module, the single-phase power reception module includes a first single-phase power output terminal coupled to the first, third, fifth, seventh, ninth, eleventh, . . . , (6N−5)th, (6N−3)th, and (6N−1)th input terminals, and a second single-phase power output terminal coupled to second, fourth, sixth, eighth, tenth, twelfth, . . . , (6N−4)th, (6N−2)th, and 6Nth input terminals, and outputs the external single-phase power from the first and second single-phase power output terminals, and the three-phase power reception module includes a first three-phase power output terminal coupled to the first, third, seventh, ninth, . . . , (6N−5)th, and (6N−3)th input terminals, a second three-phase power output terminal coupled to second, fifth, eighth, eleventh, . . . , (6N−4)th, and (6N−1)th input terminals, and a third three-phase output terminal coupled to the fourth, sixth, tenth, twelfth, . . . , (6N−2)th, and 6Nth input terminals, and outputs the external three-phase power from the first, second and third three-phase power output terminals.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a state where an example of a single-phase power supply apparatus is formed in one embodiment of the present invention;

FIG. 2 is a perspective view illustrating the state where the example of the single-phase power supply apparatus is formed in one embodiment of the present invention;

FIG. 3 is a diagram illustrating a waveform of a single-phase A.C. output;

FIG. 4 is a block diagram illustrating a state where an example of a three-phase power supply apparatus is formed in one embodiment of the present invention;

FIG. 5 is a perspective view illustrating the state where the example of the three-phase power supply apparatus is formed in one embodiment of the present invention; and

FIG. 6 is a diagram illustrating a waveform of a three-phase A.C. output.

### DESCRIPTION OF EMBODIMENTS

Preferred embodiments of the present invention will be described with reference to the accompanying drawings.

In one embodiment of the present invention, a power supply apparatus includes a power supply circuit and a power reception module. The power reception module receives power for an equipment from an external power supply, and distributes the received power to the power supply circuit.

The power reception module has a replaceable or detachable structure. The power supply apparatus may cope with an equipment that uses a single-phase power supply by attaching a single-phase power reception module to the power supply apparatus. On the other hand, the power supply apparatus may cope with an equipment that uses a three-phase power supply by attaching a three-phase power reception module to the power supply apparatus.

The manufacturer of the power supply apparatus only needs to manufacture one kind of power supply apparatus, that is, power supply apparatuses having the same structure and the same specifications, with the exception of the reception module. The manufacturer only needs to manufacture two kinds of reception modules, namely, the single-phase reception module and the three-phase reception module. For this reason, it is possible to improve the productivity of the manufacturer of the power supply apparatus.

On the other hand, when the user changes the type of power that is used in the equipment, the user only needs to replace the power reception module of the power supply apparatus to a power reception module that conforms to the type of power to be used by the equipment. Accordingly, it is possible to simplify the utility or equipment work associated with the power supply apparatus when the user changes the type of the power supply apparatus used by the equipment.

A description will now be given of the power supply apparatus in each embodiment according to the present invention.

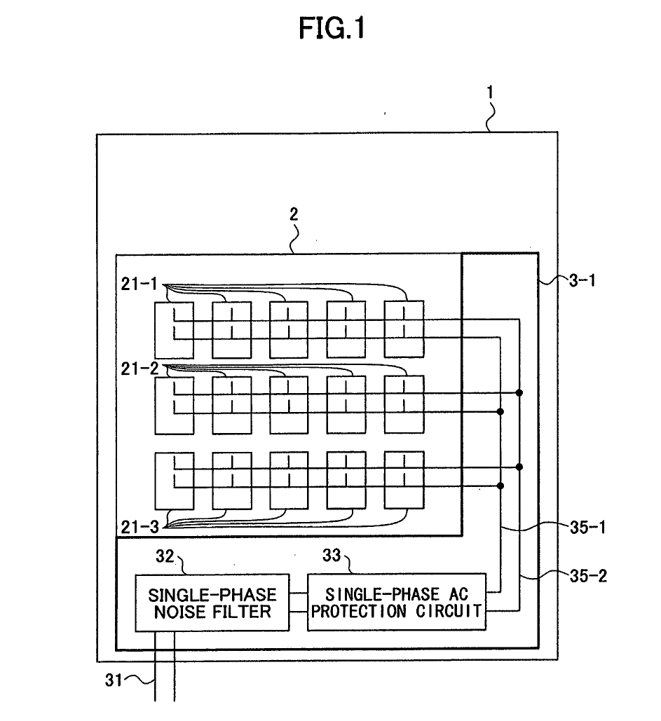

FIG. 1 is a block diagram illustrating a state where an example of a single-phase power supply apparatus is formed in one embodiment of the present invention. A power supply apparatus 1 includes a power supply part 2 for outputting a power supply voltage to the outside, and a replaceable or detachable power reception module. In FIG. 1, a single-phase power reception module 3-1 is attached to the power supply apparatus 1. In this embodiment, the power supply part 2 includes 5 first power supply circuits 21-1, 5 second power supply circuits 21-2, and 5 third power supply circuits 21-3. Each of the power supply circuits 21-1, 21-2 and 21-3 has 2 input terminals. Each first power supply circuit 21-1 has first and second input terminals for inputting single-phase power via the power reception module that is attached to the power supply apparatus 1 (hereinafter referred to as the connected power reception module). Each second power supply circuit 21-2 has third and fourth input terminals for inputting single-phase power via the connected power reception module. Each third power supply circuit 21-3 has fifth and sixth input terminals for inputting single-phase power via the connected power reception module. Hence, the total number of power supply circuits 21-1, 21-2 and 21-3 forming the power supply part 2 is set to a multiple of 3 (in this case, 15).

The single-phase power reception module 3-1 has a single-phase power cable 31 for inputting external single-phase power from outside the power supply apparatus 1, a single-phase noise filter 32 for eliminating noise from the single-phase power, a single-phase A.C. protection circuit 33 for protecting the single-phase power reception module 3-1 from excessive current, and single-phase power output terminals 35-1 and 35-2. Circuits having known structures may be used for each of the single-phase noise filter 32 and the single-phase A.C. protection circuit 33. The first single-phase power output terminal 35-1 is connected to first, third and fifth input terminals of each of the power supply circuits 21-1, 21-2 and 21-3 via known connecting parts or means, such as cables. In addition, the second single-phase power output terminal 35-1 is connected to second, fourth and sixth input terminals of each of the power supply circuits 21-1, 21-2 and 21-3 via known connecting parts or means, such as cables. Single-phase power, obtained by passing the external single-phase power through the single-phase noise filter 32 and the single-phase A.C. protection circuit 33, is output from the first and second single-phase power output terminals 35-1 and 35-2. Of course, connections between the first single-phase power output terminal 35-1 and the first, third and fifth input terminals of each of the power supply circuits 21-1, 21-2 and 21-3, and connections between the second single-phase power output terminal 35-2 and the second, fourth and sixth input terminals of each of the power supply circuits 21-1, 21-2 and 21-3 are desirably achieved by mechanisms or means that enable easy attachment and removal of the single-phase power reception module 3-1 to and from the power supply apparatus 1.

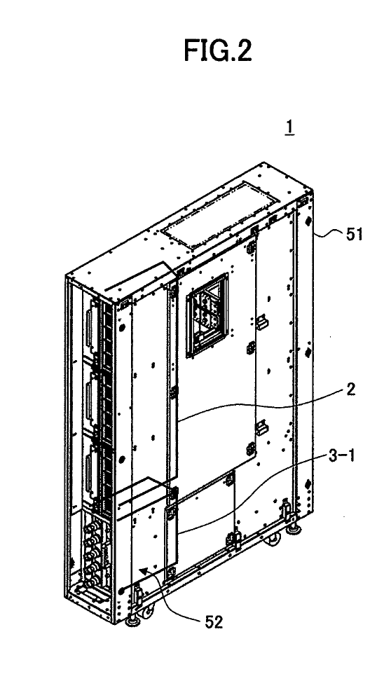

FIG. 2 is a perspective view illustrating the state where the example of the single-phase power supply apparatus is formed in one embodiment of the present invention. The power supply apparatus 1 illustrated in FIG. 2 has a housing 51 that accommodates the power supply part 2, the single-phase power reception module 3-1, and a power module mounting part 52 that is configured to receive a power reception module in a detachable manner. As described above, the single-phase power reception module 3-1 has the replaceable or detachable structure. Hence, the single-phase power reception module 3-1 is replaceably or detachably provided on the power module mounting part 52 within the housing 51. In a case where the power supply apparatus 1 supplies the power to an equipment such as a server, the height, the width and the depth of the housing 51 (that is, the power supply apparatus 1) respectively are 180 cm, 30 cm and 100 cm, for example.

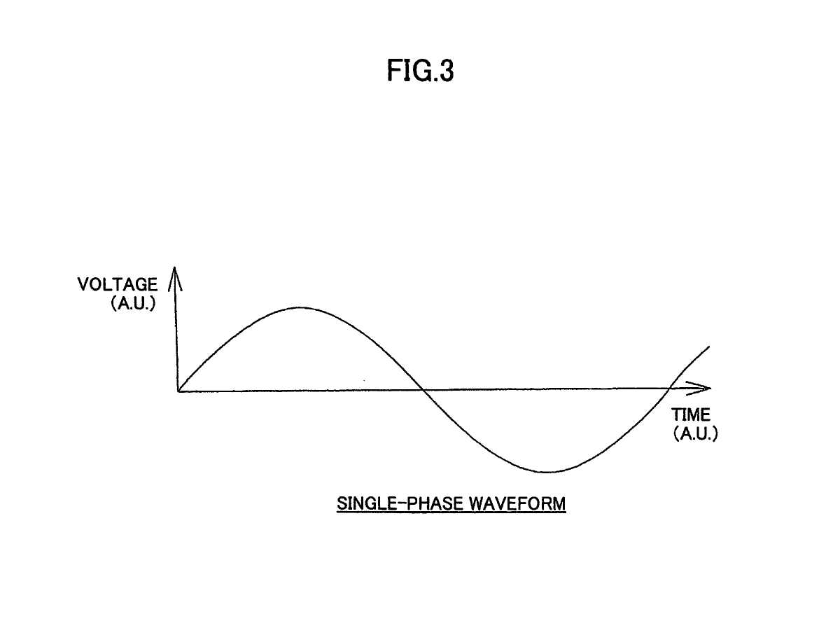

FIG. 3 is a diagram illustrating a waveform of a single-phase A.C. output. The single-phase A.C. output having the waveform illustrated in FIG. 3 is obtained from the first and second single-phase power output terminals 35-1 and 35-2. In FIG. 3, the ordinate indicates the voltage in arbitrary units (A.U.), and the abscissa indicates the time in arbitrary units (A.U.).

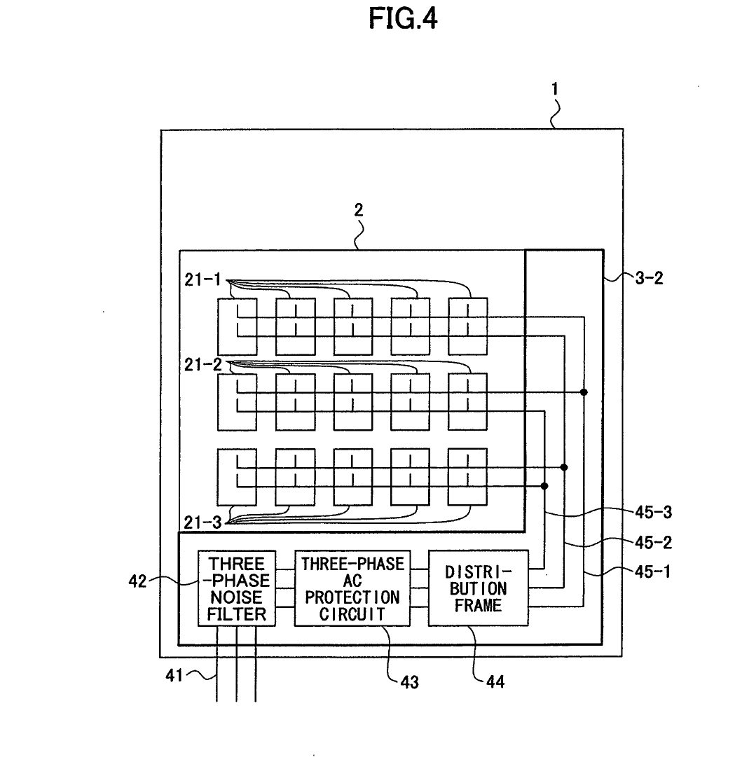

FIG. 4 is a block diagram illustrating a state where an example of a three-phase power supply apparatus is formed in one embodiment of the present invention. In FIG. 4, those parts that are the same as those corresponding parts in FIG. 1 are designated by the same reference numerals, and a description thereof will be omitted. A power supply apparatus 1 includes a power supply part 2 for outputting a power supply voltage to the outside, and a replaceable or detachable power reception module. In FIG. 4, a three-phase power reception module 3-2 is attached to the power supply apparatus 1.

The three-phase power reception module 3-2 has a three-phase power cable 41 for inputting external three-phase power from outside the power supply apparatus 1, a three-phase noise filter 42 for eliminating noise from the three-phase power, a three-phase A.C. protection circuit 43 for protecting the three-phase power reception module 3-2 from excessive current, a distribution frame (or terminal board) 44, and three-phase power output terminals 45-1, 45-2 and 45-3. Circuits having known structures may be used for each of the three-phase noise filter 42 and the three-phase A.C. protection circuit 43. The first three-phase power output terminal 45-1 is connected to first and third input terminals of each of the power supply circuits 21-1 and 21-2 via the distribution frame 44 and known connecting parts or means, such as cables. In addition, the second three-phase power output terminal 45-2 is connected to second and fifth input terminals of each of the power supply circuits 21-1 and 21-3 via the distribution frame 44 and known connecting parts or means, such as cables. Further, the third three-phase power output terminal 45-3 is connected to fourth and sixth input terminals of each of the power supply circuits 21-2 and 21-3 via the distribution frame 44 and known connecting parts or means, such as cables. Three-phase power, obtained by passing the external three-phase power through the three-phase noise filter 42, the three-phase A.C. protection circuit 43 and the distribution frame 44, is output from the first, second and third three-phase power output terminals 45-1, 45-2 and 45-3. Of course, connections between the first three-phase power output terminal 45-1 and the first and third input terminals of each of the power supply circuits 21-1 and 21-2, connections between the second three-phase power output terminal 45-2 and the second and fifth input terminals of each of the power supply circuits 21-1 and 21-3, and connections between the third three-phase power output terminal 45-3 and the fourth and sixth input terminals of each of the power supply circuits 21-2 and 21-3 are desirably achieved by mechanisms or means that enable easy attachment and removal of the single-phase power reception module 3-2 to and from the power supply apparatus 1.

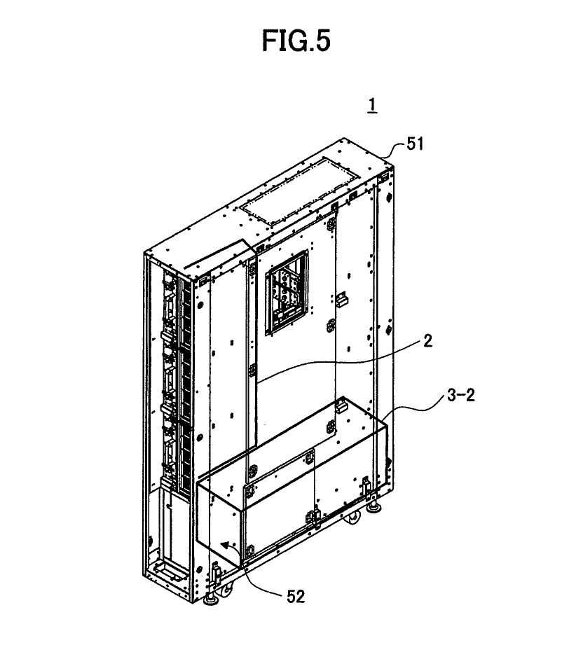

FIG. 5 is a perspective view illustrating the state where the example of the three-phase power supply apparatus is formed in one embodiment of the present invention. In FIG. 5, those parts that are the same as those corresponding parts in FIG. 2 are designated by the same reference numerals, and a description thereof will be omitted. The power supply apparatus 1 illustrated in FIG. 5 has a housing 51 that accommodates the power supply part 2, the three-phase power reception module 3-2, and a power module mounting part 52 that is configured to receive a power reception module in a detachable manner. As described above, the three-phase power reception module 3-2 has the replaceable or detachable structure. Hence, the three-phase power reception module 3-2 is replaceably or detachably provided on the power module mounting part 52 within the housing 51.

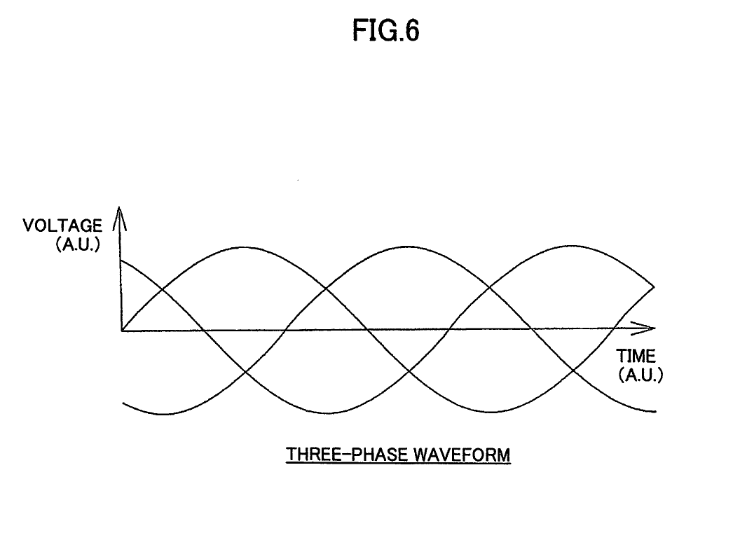

FIG. 6 is a diagram illustrating a waveform of a three-phase A.C. output. The three-phase A.C. output having the waveform illustrated in FIG. 6 is obtained from the first, second and third three-phase power output terminals 45-1, 45-2 and 45-3. In FIG. 6, the ordinate indicates the voltage in arbitrary units (A.U.), and the abscissa indicates the time in arbitrary units (A.U.). The A.C. power outputs from the first, second and third three-phase power output terminals 45-1, 45-2 and 45-3 are single-phase A.C. powers having a mutual phase difference of 120 degrees or approximately 120 degrees, as illustrated in FIG. 6.

In the embodiment described above, the power supply part 2 has 5 first power supply circuits 21-1, 5 second power supply circuits 21-2, and 5 third power supply circuits 21-3. However, the number of each of the first, second and third power supply circuits 21-1, 21-2 and 21-3 is of course not limited to 5. The number of each of the first, second and third power supply circuits 21-1, 21-2 and 21-3 may be 1 or greater, as long as the total number of the first, second and third power supply circuits 21-1, 21-2 and 21-3 is a multiple of 3 as described above.

For example, if the number of each of the first, second and third power supply circuits 21-1, 21-2 and 21-3 is 2 or greater, the following relationship stands.

In other words, the power supply part includes first through (3N−1) power supply circuits (where N is an integer greater than or equal to 3) having a pair of first and second input terminals, a pair of seventh and eighth input terminals, . . . , and a pair of (6N−5)th and (6N−4)th input terminals, and inputting single-phase powers from the pair of first and second input terminals, the pair of seventh and eighth input terminals, . . . , and the pair of (6N−5)th and (6N−4)th input terminals; second through (3N−2)th power supply circuits having a pair of third and fourth input terminals, a pair of ninth and tenth input terminals, . . . , and a pair of (6N−3)th and (6N−2)th input terminals, and inputting single-phase powers from the pair of third and fourth input terminals, the pair of ninth and tenth input terminals, . . . , and the pair of (6N−3)th and (6N−2)th input terminals; and third through 3Nth power supply circuits having a pair of fifth and sixth input terminals, a pair of eleventh and twelfth input terminals, . . . , and a pair of (6N−1)th and 6Nth input terminals, and inputting single-phase powers from the pair of fifth and sixth input terminals, the pair of eleventh and twelfth input terminals, . . . , and the pair of (6N−1)th and 6Nth input terminals.

In this case, the single-phase power reception module includes a first single-phase power output terminal connected to the first, third, fifth, seventh, ninth, eleventh, . . . , (6N−5)th, (6N−3)th, and (6N−1)th input terminals, and a second single-phase power output terminal connected to second, fourth, sixth, eighth, tenth, twelfth, . . . , (6N−4)th, (6N−2)th, and 6Nth input terminals, and outputs the external single-phase power from the first and second single-phase power output terminals.

On the other hand, the three-phase power reception module includes a first three-phase power output terminal connected to the first, third, seventh, ninth, . . . , (6N−5)th, and (6N−3)th input terminals, a second three-phase power output terminal connected to second, fifth, eighth, eleventh, . . . , (6N−4)th, and (6N−1)th input terminals, and a third three-phase output terminal connected to the fourth, sixth, tenth, twelfth, . . . , (6N−2)th, and 6Nth input terminals, and outputs the external three-phase power from the first, second and third three-phase power output terminals.

Therefore, the embodiment of the present invention is applicable to a power supply apparatus that is used in an environment in which a plurality of types of power are usable by the equipment such as the server.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply apparatus comprising:
a first power supply circuit having first and second input terminals and configured to input single-phase A.C. power from the first and second input terminals;
a second power supply circuit having third and fourth input terminals and configured to input the single-phase A.C. power from the third and fourth input terminals;
a third power supply circuit having fifth and sixth input terminals and configured to input the single-phase A.C. power from the fifth and sixth input terminals; and
a replaceable power reception module selected from a group consisting of a single-phase power reception module and a three-phase power reception module,
wherein the single-phase power reception module includes a first single-phase power output terminal coupled to the first, third and fifth input terminals, and a second single-phase power output terminal coupled to the second, fourth and sixth input terminals, and outputs external single-phase A.C. power from the first and second single-phase power output terminals, and
the three-phase power reception modules includes a first three-phase power output terminal coupled to the first and third input terminals, a second three-phase power output terminal coupled to the second and fifth input terminal, and a third three-phase power output terminal coupled to the fourth and sixth input terminals, and outputs external three-phase A.C. power from the first, second and third three-phase power output terminals.

2. The power supply apparatus as claimed in claim 1, wherein A.C. power outputs from the first, second and third three-phase power output terminals are single-phase A.C. powers having a mutual phase difference of 120 degrees or approximately 120 degrees.

3. The power supply apparatus as claimed in claim 1, wherein the single-phase power reception module comprises:
a single-phase power cable configured to input the external single-phase A.C. power;
a single-phase noise filter configured to eliminate noise from the external single-phase A.C. power; and
a single-phase A.C. protection circuit configured to protect the single-phase power reception module from excessive current.

4. The power supply apparatus as claimed in claim 1, wherein the three-phase power reception module comprises:
a three-phase power cable configured to input the external three-phase A.C. power;
a three-phase noise filter configured to eliminate noise from the external three-phase A.C. power; and
a three-phase A.C. protection circuit configured to protect the three-phase power reception module from excessive current.

5. A power supply apparatus comprising:
a power reception module comprising:
first through (3N−1) power supply circuits having a pair of first and second input terminals, a pair of seventh and eighth input terminals, . . . , and a pair of (6N−5)th and (6N−4)th input terminals, and inputting single-phase powers from the pair of first and second input terminals, the pair of seventh and eighth input terminals, . . . , and the pair of (6N−5)th and (6N−4)th input terminals, where N is an integer greater than or equal to 3;
second through (3N−2)th power supply circuits having a pair of third and fourth input terminals, a pair of ninth and tenth input terminals, . . . , and a pair of (6N−3)th and (6N−2)th input terminals, and inputting single-phase powers from the pair of third and fourth input terminals, the pair of ninth and tenth input terminals, . . . , and the pair of (6N−3)th and (6N−2)th input terminals; and
third through 3Nth power supply circuits having a pair of fifth and sixth input terminals, a pair of eleventh and twelfth input terminals, . . . , and a pair of (6N−1)th and 6Nth input terminals, and inputting single-phase powers from the pair of fifth and sixth input terminals, the pair of eleventh and twelfth input terminals, . . . , and the pair of (6N−1)th and 6Nth input terminals; and
a power module mounting part configured to receive the power reception module in a detachable manner,
wherein the power reception module is selected from a group consisting of a single-phase power reception module and a three-phase power reception module,
the single-phase power reception module includes a first single-phase power output terminal coupled to the first, third, fifth, seventh, ninth, eleventh, . . . , (6N−5)th, (6N−3)th, and (6N−1)th input terminals, and a second single-phase power output terminal coupled to second, fourth, sixth, eighth, tenth, twelfth, . . . , (6N−4)th, (6N−2)th, and 6Nth input terminals, and outputs the external single-phase power from the first and second single-phase power output terminals, and
the three-phase power reception module includes a first three-phase power output terminal coupled to the first, third, seventh, ninth, . . . , (6N−5)th, and (6N−3)th input terminals, a second three-phase power output terminal coupled to second, fifth, eighth, eleventh, . . . , (6N−4)th, and (6N−1)th input terminals, and a third three-phase output terminal coupled to the fourth, sixth, tenth, twelfth, . . . , (6N−2)th, and 6Nth input terminals, and outputs the external three-phase power from the first, second and third three-phase power output terminals.

6. The power supply apparatus as claimed in claim 5, wherein A.C. power outputs from the first, second and third three-phase power output terminals are single-phase A.C. powers having a mutual phase difference of 120 degrees or approximately 120 degrees.

7. The power supply apparatus as claimed in claim 5, wherein the single-phase power reception module further comprises:
a single-phase power cable configured to input the external single-phase A.C. power;
a single-phase noise filter configured to eliminate noise from the external single-phase A.C. power; and
a single-phase A.C. protection circuit configured to protect the single-phase power reception module from excessive current.

8. The power supply apparatus as claimed in claim 5, wherein the three-phase power reception module further comprises:
a three-phase power cable configured to input the external three-phase A.C. power;
a three-phase noise filter configured to eliminate noise from the external three-phase A.C. power; and
a three-phase A.C. protection circuit configured to protect the three-phase power reception module from excessive current.
